(19) United States
(12) Patent Application Publication
(10) Pub. No.: US 2005/0128516 A1
(43) Pub. Date: Jun. 16, 2005

(54) Document processing apparatus and document processing method

(75) Inventor: Makoto Tomita, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/007,482

(22) Filed: Dec. 8, 2004

(30) Foreign Application Priority Data
Dec. 15, 2003 (JP) 2003-417196

(51) Int. Cl. G06F 15/00

(52) U.S. Cl. 358/1.15; 358/448

(57) ABSTRACT

A document processing apparatus includes a first determination unit for determining, as an image processing option, an object related to a predetermined print setting included in image data corresponding to a page of a source document read by an image reading unit for reading the source document as image data and an output unit for outputting the option determined by the first determination unit.

### BACKGROUND OF THE INVENTION

1. Field of the Invention

The present invention relates to document processing methods and document processing apparatuses that allow image data read by, for example, an image scanner to be saved and/or output as an electronic document.

2. Description of the Related Art

Scanners for reading a normal paper document and saving it as electronic data are widely used for the purposes of not only saving an image of the paper document as electronic data but also for editing, processing, and/or changing the electronic data to output it. More specifically, the processing of, for example, editing the read electronic data and/or adding output settings, such as double-sided printing, stapling, and punching, to the read electronic data is performed to print out the result with a printing apparatus. Attempts have also been made to integrate a scanner and an image editing apparatus into a printing apparatus with an output setting function for the sake of convenience.

Furthermore, just for the purpose of printing out, Japanese Patent Laid-Open No. 2000-115476 (paragraph 0011) proposes a method for saving electronic document data of a source document page by page with settings for, for example, double-sided printing, stapling, or punching and settings for the output format, such as a bookbinding layout.

As described above, when the user scans a paper source document with a scanner and converts it into an electronic document for saving, in general the user first performs a rough prescan of the source document to input the generated data into a PC (Personal Computer) connected to the scanner, and then enters scan settings, such as the reading position and image processing, while monitoring the data on a display unit. After completing the scan settings, the user scans the paper source document and performs printing by specifying output format settings, such as double-sided printing, stapling, or punching, on the electronic document acquired via the scanning to obtain a desired output product.

Furthermore, for a multifunction machine where a scanner and an image editing apparatus are integrated into a printing apparatus, the user specifies image processing settings for scanning, such as the read position and trimming, using setting buttons and a panel on the multifunction machine, and furthermore specifies output format settings, such as double-sided printing, stapling, or punching, to obtain a desired output product.

Furthermore, to improve the image recognition rate when a source document image is to be recognized, Japanese Patent Laid-Open No. 2000-115476 describes a technology for displaying a scanned image in a preview format to allow the user to select the object type of each area on the preview image from among a number of options. Japanese Patent Laid-Open No. 2000-115476 describes that, for example, a staple mark and a punch hole mark included in the image obtained via scanning are not displayed to the user, i.e., set as a “hidden” area.

### SUMMARY OF THE INVENTION

Accordingly, the present invention is conceived as a response to the above-described disadvantages of the conventional art.

With an electronic document produced by importing a paper source document using an image scanner, the format of the paper source document can be reproduced by a simple method.

According to an aspect of the present invention, a document processing apparatus includes: a first determination unit for determining, as an image processing option, an object related to a predetermined print setting included in image data corresponding to a page of a source document read by an image reading unit for reading the source document as image data; and an output unit for outputting the image processing option, with a form that a user can select whether the image processing option is performed, determined by the first determination unit.

According to another aspect of the present invention, a document processing method includes steps for: determining, as an image processing option, an object related to a predetermined print setting included in image data corresponding to a page of a source document read by an image reading unit for reading the source document as image data; and outputting the image processing option, with a form that user can select whether the image processing option is performed, determined.

According to still another aspect of the present invention, a computer-executable program includes instructions for: determining, as an image processing option, an object related to a predetermined print setting included in image data corresponding to a page of a source document read by an image reading unit for reading the source document as image data; and an output unit for outputting the image processing option, with a form that a user can select whether the image processing option is performed, determined.

According to yet another aspect of the present invention, a document processing apparatus includes: an image reading unit configured to read a page of a source document as image data including a predetermined print setting; an image analysis unit configured to determine, as an image processing option, processing instructions based on the predetermined print setting included in the image data corresponding to the page of the source document read by the image reading unit; and an output unit configured to output the image processing option, determined by the image analysis unit.

According to still another aspect of the present invention, a document processing method includes: reading a page of a source document as image data including a predetermined print setting; determining, as an image processing option, processing instructions based on the predetermined print setting included in the image data corresponding to the page of the source document read; and outputting the image processing option determined.

Further features and advantages of the present invention will become apparent from the following description of exemplary embodiments (with reference to the attached drawings).

### BRIEF DESCRIPTION OF THE DRAWINGS

FIG. 1 is a block diagram showing an example hardware structure of a document processing system according to an embodiment.

FIG. 2 is a diagram showing structures of a host computer and a multifunction machine constituting a document processing system according to an embodiment.

FIG. 3 is a flowchart showing an example procedure for image reading according to an embodiment.

FIG. 4 is a table showing example processing options that can be set to characteristic portions identified according to an embodiment.

FIG. 5 shows an example of an image generated according to an embodiment.

FIG. 6 is a flowchart illustrating in detail one example of image analysis according to an embodiment.

FIG. 7 is a diagram showing examples of print areas according to an embodiment.

FIG. 8 is a block diagram showing an example hardware structure of a document processing system according to an embodiment.

FIG. 9 is a flowchart showing an example procedure for image reading according to an embodiment.

FIG. 10 is a diagram showing a structure of a document processing system according to an embodiment.

FIG. 11 is a diagram showing an example structure of a book file.

FIG. 12 shows examples of book attributes according to an embodiment.

FIG. 13 shows examples of chapter attributes according to an embodiment.

FIG. 14 shows examples of page attributes according to an embodiment.

FIG. 15 shows an example data structure of a job ticket.

### DESCRIPTION OF THE EMBODIMENTS

An exemplary embodiment of the present invention will now be described in detail with reference to the drawings. It should be noted that the relative arrangement of the components, the numerical expressions and numerical values set forth in these embodiments do not limit the scope of the present invention unless specifically stated otherwise.

### First Embodiment

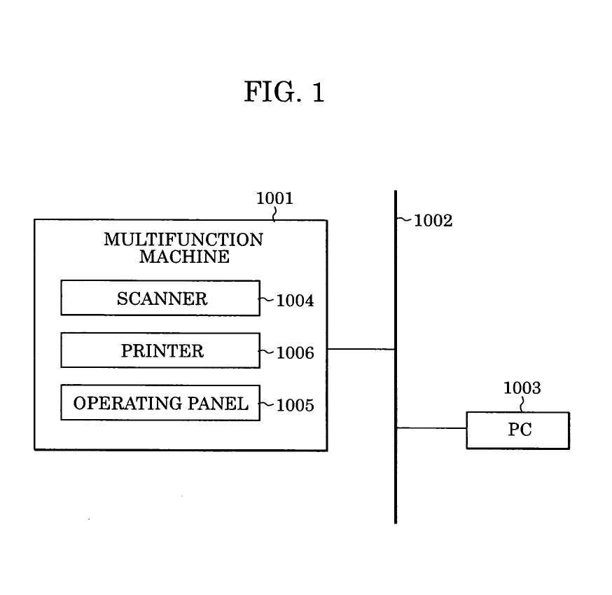

Exemplary embodiments according to the present invention will now be described with reference to the drawings. FIG. 1 is a block diagram for describing the structure of a document processing system of an exemplary embodiment of the present invention. In FIG. 1, a multifunction machine 1001 is provided with scanner and printer functions, and also serves as a copier by utilizing the respective functions independently. The multifunction machine 1001 is connected to a network 1002 via a network cable such as an Ethernet cable. The multifunction machine 1001 optically reads a paper source document and converts it into digital image data, which can then be transferred to a computer 1003 via the network 1002. Similarly, the computer 1003 is connected to the network 1002. The computer 1003 can execute various types of programs such as application programs. Furthermore, the computer 1003 is provided with a printer driver having a function for converting print data into a printer language supported by the printer, and thus the computer 1003 transmits print commands to the multifunction machine 1001. The multifunction machine 1001 can perform printing according to the print commands received via the network 1002.

Furthermore, the present invention can also be applied to a structure where the scanner and printer functions are separately connected to the network 1002.

Example Hardware Structure of Document Processing System

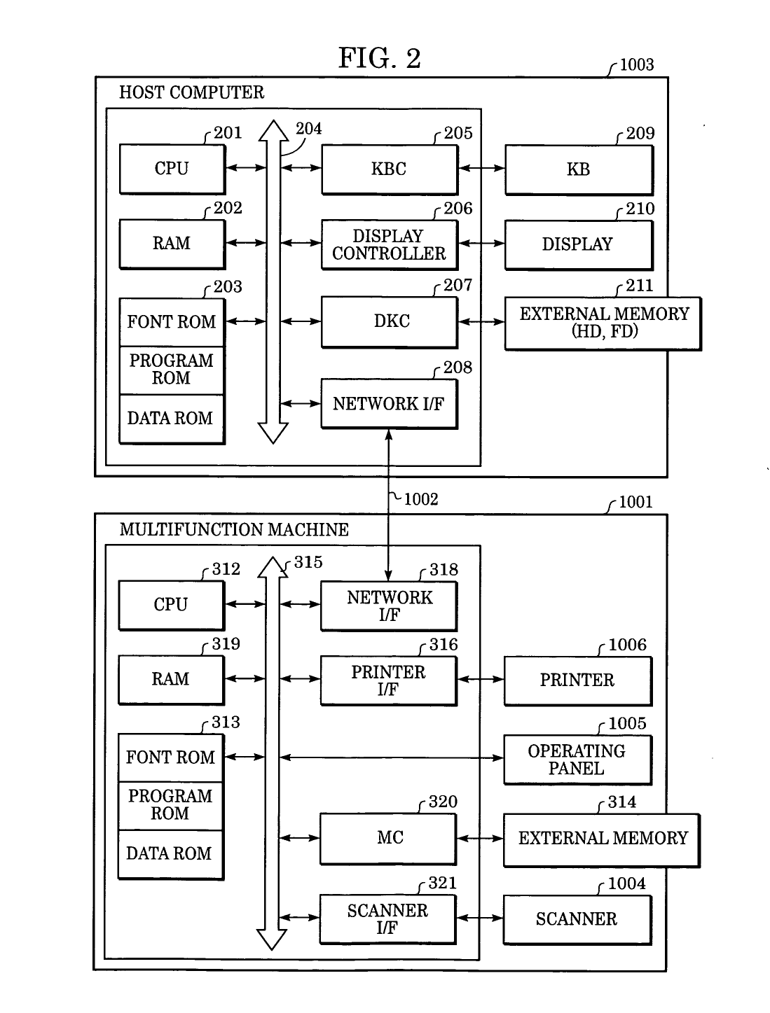

FIG. 2 is a diagram showing a hardware structure of a document processing system according to this embodiment. The host computer 1003 in FIG. 2 includes a CPU (Central Processing Unit) 201 which, on the basis of a document processing program stored in a program ROM (Read-Only Memory) in a ROM 203 or in an external memory 211, executes the processing of a document containing mixed objects, such as graphics, images, characters and tables (inclusive of spreadsheets, etc.). The CPU 201 performs overall control of various devices connected to a system bus 204. An operating system, which is the control program of the CPU 201, is stored in the program ROM of the ROM 203 or in the external memory 211. Font data used when the above-mentioned document processing is executed is stored in a font ROM of the ROM 203 or in the external memory 211. Various data used when the above-mentioned document processing is executed is stored in a data ROM of the ROM 203 or in the external memory 211. A RAM (Random Access Memory) 202 functions as the main memory and work area of the CPU 201.

A keyboard controller (KBC) 205 controls inputs from a keyboard 209 and a pointing device (not shown). A CRT controller (CRTC) 206 controls the display on a CRT display (CRT) 210. A disk controller (DKC) 207 controls access to the external memory 211, such as a hard disk (HD) or a floppy disk (FD). The hard disk stores a booting program, various applications, font data, user files, edited files, a scanner control program (scanner driver), and a program for generating printer control commands (hereinafter, referred to as a “printer driver”). A network interface (external I/F) 208 is connected to a network 1002 such as a LAN to execute processing for controlling communication with the multifunction machine 1001.

The CPU 201 executes a procedure in a flowchart to be described later. The CPU 201 further executes a bookbinding application (print control application), a print application (despooler), and the operating system including a graphic engine, a software driver of the multifunction machine 1001, etc., which are also described later. The hard disk 211 stores a save file, an edit information file, etc. to be described later.

The multifunction machine 1001 is controlled by a CPU 312. On the basis of a control program stored in a program ROM of a ROM 313 or a control program stored in an external memory 314, the printer CPU 312 outputs an image signal, which serves as output information, to a printer (printer engine) 1006 connected to a system bus 315 via a printer interface 316. The control program for the CPU 312 is stored in the program ROM of the ROM 313. Font data used when the above-mentioned output information is generated is stored in a font ROM of the ROM 313. In the case of a printer not equipped with the external memory 314 such as a hard disk, information utilized in the host computer 1003 is stored in a data ROM of the ROM 313. The CPU 312 analyzes a command received from the host computer 1003 and controls the entire printer 1006 such that the printer 1006 performs processing according to the command.

The CPU 312, which can execute processing for communicating with the host computer 1003 via a network interface 318, is capable of notifying the host computer 1003 of information internal to the printer 1006. A RAM 319, which functions as the main memory and work area of the CPU 312, is so adapted that memory capacity can be expanded by optional RAM connected to an add-on memory port (not shown). The RAM 319 is used as an expansion area for expanding output information, as a storage area for storing environment data, and as an NVRAM (Non-Volatile RAM). The external memory 314, such a hard disk (HD) or IC (Integrated Circuit) card, has its access controlled by a memory controller (MC) 320. The external memory 314, which is connected as an option, stores font data, an emulation program, and form data, etc. Further, an operating unit (an operating panel) 1005 has an array of operation switches and a liquid crystal panel.

A plurality of external memories 314 may be provided rather than just one. In such a case, optional fonts to supplement the internal fonts can be stored in each external memory 314 as well as programs for interpreting printer control languages of different language systems. Furthermore, the external memory 314 may have an NVRAM (not shown) for storing printer mode setting information from the operating panel 1005.

A scanner unit 1004 is connected to the system bus 315 via a scanner unit interface 321. The scanner unit 1004 is controlled by the CPU 312. The scanner unit 1004 illuminates a source document image with light from a light source, focuses the reflected light on an image sensor, such as a CCD (Charge-Coupled Device) and CMOS (Complementary Metal Oxide Semiconductor), via an optical system to convert it to electronic form, and further converts the electronic signal into a digital signal to pass it to the scanner unit interface 321. Alternatively, a CIS (Cerberus Internet Scanner) may be used. Furthermore, the scanner unit 1004 is provided with an automatic document feeder (ADF) which allows the source documents loaded on a paper-feed unit to be transported to the reading position one sheet at a time, so that two or more source documents can automatically be read. In addition, the ADF is provided with a sheet reverse function for consecutively reading the front and back faces of one sheet. In this case, image data corresponding to the front face of one sheet is regarded as one-page of image data and is sent to the host computer 1003. Thereafter, the sheet is turned over to read the back face of the sheet. Data of the back face also corresponds to one-page of image data, which is also sent to the host computer 1003.

Overview of Document Processing System

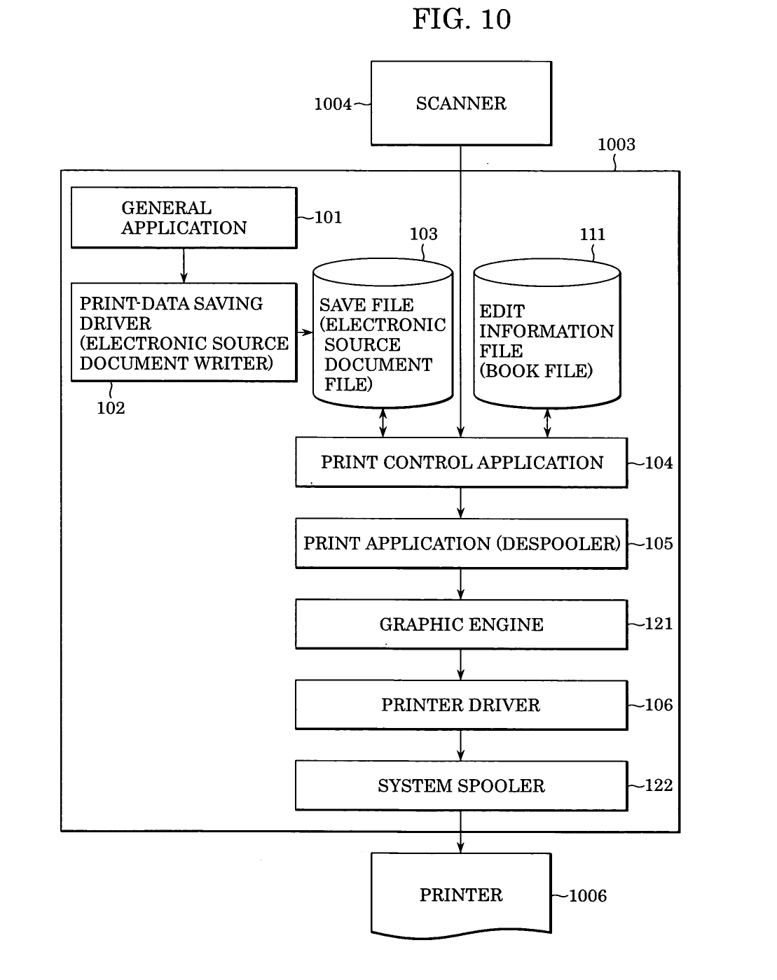

The overview of a document processing system representing an embodiment according to the present invention will now be described with reference to FIG. 10 to FIG. 15. In this document processing system, a data file generated by a general-purpose application is converted into electronic source document data by a print-data saving driver (also referred to as an electronic source document writer), and saved in a save file (also referred to as an electronic source document file). A print control application (also referred to as a bookbinding application) provides a function for editing the save file. Furthermore, an edit information file linked with the save file is generated when the save file is edited by the print control application. The content of the save file is read by a print application (also referred to as a despooler) via the print control application and is supplied for printing. Although this example is described by classifying the functions into the general-purpose application, the print-data saving driver, the print control application, and the print application to clarify the respective functions, a package supplied to the user is not limited to such a software configuration. These programs may be integrated into one application or graphic engine supplied to the user. Details are described below.

Example Software Configuration of Document Processing System

FIG. 10 is a diagram showing the software configuration of a document processing system according to this embodiment. The document processing system is realized by a digital computer 1003 (hereinafter, referred to as a host computer) representing an exemplary embodiment of a document processing apparatus (information processing apparatus) according to the present invention. A general-purpose application 101 is an application program for providing functions such as word processing, spreadsheet calculation, photo-retouching, drawing or painting, presentation, and text editing. The general-purpose application 101 also has a function for making a request for print processing to the operating system (OS). This application 101 utilizes a predetermined interface provided by the OS to print out generated application data, such as document data and image data. More specifically, the application 101 issues an output command in a predetermined format to the output module of the OS that provides the above-described interface to print out generated data. The output module that has received the output command converts the command into a format that can processed by an output device such as a printer, and outputs the converted command. Since formats that can be processed by the output device differ depending on the type, manufacturer, and model of each device, one device driver is provided for each device. The OS converts the command via the device driver to generate print data, and expresses the print data in a JL (Job Language) to generate a print job.

If the OS used is Microsoft Windows®, a module called the Graphic Device Interface (GDI) is used as the output module. The application 101 calls the GDI function with the generated data as a parameter in a format in compliance with the GDI. Thus, the OS receives the above-described output command.

The print-data saving driver 102 is an improved version of the above-described device driver. It is a software module provided to realize this document processing system. It is noted, however, that the print-data saving driver 102 is not intended for a particular output device. Instead, the print-data saving driver 102 converts the output command into a format that can be processed by a print control application 104 and a printer driver 106, to be described later. For the format after being converted by this print-data saving driver 102 (hereinafter, referred to as “save file format”), any format that can represent a document structure and a page-by-page source document in detail is acceptable. Formats of a save file that can represent a page-by-page source document include, for example, the Adobe Systems® PDF format and the SVG (Scalable Vector Graphics) format.

In the system shown in FIG. 10, the data in a save file 103 can be manipulated. In other words, it is possible to realize functions not possessed by the application 101. For example, document pages can be subjected to size enlargement and reduction, and a plurality of pages may be printed upon being reduced to the size of a single page. In order to attain these objectives, the system of FIG. 10 is expanded in such a manner that print data is spooled in the form of intermediate code (job ticket). In order to manipulate the print data, the user usually makes settings using a window provided by the print control application 104 and the settings are saved in the RAM 202 or external memory 211.

As shown in FIG. 10, in this extended processing method, print data from the application 101 is saved in the system as the save file 103 via the print-data saving driver 102 or the scanner 1004. This save file 103 is also referred to as an intermediate file, and includes content data, print setting data, etc. of a print product. The content data of a print product is such data as generated by converting data generated by the user with an application into intermediate code, whereas the print setting data is data describing how the content data is to be output (e.g., output format). In addition, there is extended data for an application called an edit information file 111 for providing a user interface that allows the user to edit and output the content of the save file 103 with the print control application 104. The edit information file 111 stores not only extended data for providing the user interface but also print setting data that cannot be saved in the save file 103. For this reason, if, for example, a standardized format is used as the format of the save file 103, print settings that cannot be saved in the format can be saved in the edit information file 111. According to this embodiment, the edit information file 111 and the save file 103 may be handled as the same files.

According to this embodiment, an electronic source document is acquired by the source document scanner 1004. In that case, data on which the electronic document is based enters the print control application 104 without passing through the print-data saving driver 102, is converted into, for example, the Adobe Systems® PDF format page by page, and is saved in the save file 103 and the edit information file 111 as an electronic document. In this case, according to this embodiment, the save file 103 saves data in a standard format called a job ticket. The edit information file 111 saves document data for describing a hierarchical structure including “book (document)”, “chapter”, and “page” specific to the document processing system according to this embodiment. According to this embodiment, the save file 103 and the edit information file 111 may be collectively referred to as an electronic source document file. Furthermore, the print-data saving driver 102 may be referred to as an electronic source document writer, in that the driver 102 is a program for generating an electronic source document file.

The save file 103 thus saved is read by the print control application 104. This print control application 104 expands the content of the save file 103 as a table in memory, and furthermore, if the edit information file 111 includes a specific setting not included in the save file 103, the print control application 104 reflects the setting in the table expanded in the memory. Thereafter, the output format of the content of the read save file 103 can be changed, displayed, saved, and printed out. The print application (despooler) 105 is responsible for print processing. The print application (despooler) 105 that has received a print command from the print control application 104 inputs data to a graphic engine 121 in a predetermined format, such as the format of the GDI function, according to the output format set by the print control application 104. The graphic engine 121 converts the input data, for example, in the GDI function format into the DDI (device driver interface) function format, which is then output to the printer driver 106. The printer driver 106 generates a printer control command including, for example, a page description language (PDL) based on the DDI function acquired from the graphic engine 121, and outputs the command to the printer 1006 via a system spooler 122.

Example Data Format of Save File

The data format of the save file 103 is described next, followed by details of the print control application 104. The save file 103 includes data of each source document page (page-based data generated by the application, also referred to as a logical page) as content data, and furthermore, includes data in a format called, for example, a job ticket as print setting data. Furthermore, along with the save file 103, the edit information file 111 to be referred to specifically by the print control application 104 (described later) is also generated. In the save file 103, source document page data in the PDF format and data in the format called a job ticket serve as intermediate data.

In the save file 103, source document page data is defined, for example, in the PDF format, and includes the specification of the font and color of characters, characters/graphics layout information on the source document page, etc.

A job ticket saved as the save file 103 has a structure including source document pages as minimum building blocks. The structure of the job ticket defines the layout of the source document page on a sheet. One job ticket corresponds to one print job. The top layer corresponds to the node of the entire document, where attributes of the entire document, such as double-sided printing/single-sided printing, are defined. The layer below the top layer includes information regarding attributes of the document structure and each component. More specifically, the layer below the top layer corresponds to sheet-bundle nodes, where attributes such as the identifiers of used sheets and the specification of paper feed port in the printer are included. Each sheet-bundle node includes nodes of the sheets included therein. One sheet corresponds to one sheet of paper. Each sheet includes print pages (physical pages). In the case of single-sided printing, one sheet includes one physical page. In the case of double-sided printing, one sheet includes two physical pages. Each physical page includes a source document page laid out on the physical page. Furthermore, the layout of the source document page is included as an attribute of the physical page. A source document page includes information (link information) associated with the source document page data, which represents the source document page.

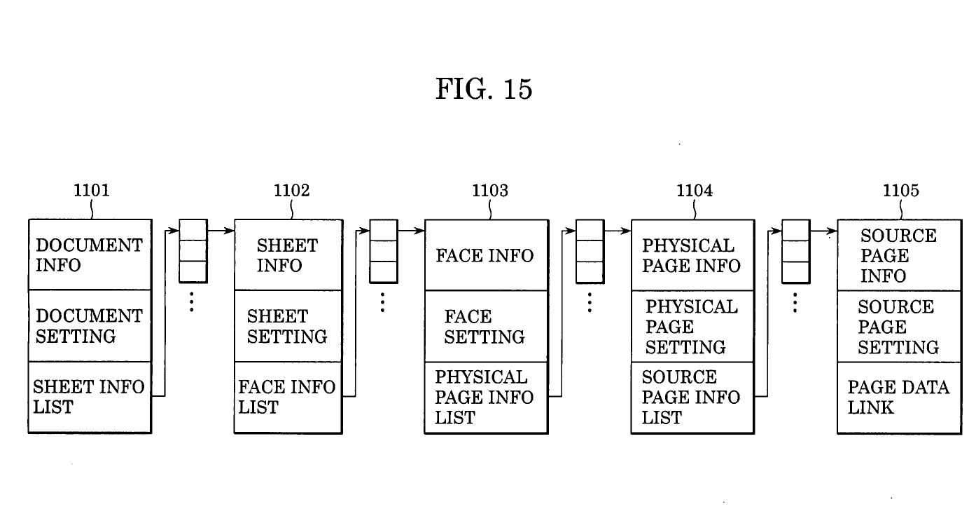

FIG. 15 shows an example data structure of the job ticket. In print data, a document includes a collection of sheets, each of which includes two faces: front face and back face. Each of the front and back faces has an area (physical page) on which the source document is laid out. Each of the physical pages includes a collection of source document pages, which are the minimum building blocks. Data 1101 corresponds to a document, and includes data related to the entire document and a list of sheet information items constituting the document. Sheet information 1102 includes information regarding sheets, such as sheet size, and a list of face information arranged on the sheet. Face information 1103 includes face-specific data and a list of physical pages arranged on the face. Physical page information 1104 includes information such as the physical page size, the header, and the footer and a list of source document pages constituting the physical page. Source document page information 1105 includes the setting of source document page and a link to page data representing the content of the page.

The entire document includes, for example, the following attributes.
(1) Information regarding the arrangement and order of source document pages on a physical page (indicating a face of a sheet of a printing medium), such as a so-called N-up print setting for arranging N pages on one physical page
(2) Document name
(3) Enabling/disabling the specification of double-sided printing
(4) Enabling/disabling the setting of variable printing
(printing technology for embedding separately provided data as the content of a predetermined field)
(5) Number of source document pages
(6) Color type
(7) Number of copies, etc.
(8) Watermark (textures superimposed on a source document page or a print page)
(9) Printer status
(10) Medium type
(11) List of logical page numbers on sheet
(12) Print quality, etc.

Each sheet bundle includes the following attributes.
(13) Specification of N-up printing
(14) Color type
(15) Paper-feed source, etc.

Each of the sheets included in a sheet bundle includes the following attributes.
(16) Setting of double-sided/single-sided printing

Each of the physical pages (faces) included in a sheet includes the following attributes.
(17) Color type
(18) Specification of either front face or back face

Each of the source document pages arranged on a physical page includes the following attributes.
(19) Start coordinates
(20) Size
(21) Order

As described above, the job ticket has a hierarchical structure where source document pages are minimum building blocks. Many of the print settings defined by the job ticket are common on each layer specified on a document-by-document basis. Some print settings, however, are common across the layers, such as settings of the N-up attribute and color type attribute. The same attributes in a layer as those in the upper layer basically follow the same settings as those in the upper layer. If an attribute on a layer has a different setting as the corresponding attribute on an upper layer, the setting on the layer of interest is used as the setting of the attribute. For example, the setting of the color type attribute can be different for the entire document, a sheet bundle, and a physical page (face, also called a print page). The color type is an attribute for specifying the mode of the printing apparatus. If the color type is set to the monochrome mode, print data for making the printing apparatus print out a monochrome image is generated. In contrast, if the color type is set to the color mode, print data for making the printing apparatus print out a color image is generated.

Document Structure Managed by Edit Information File

The print control application 104 is a program for providing a user interface that allows the user to specify data included in the save file 103, and furthermore to change print settings in various manners. The save file 103 itself is a file having the above-described structure. The print control application 104 associates the above-described edit information file 111 with the save file 103 independently of the save file 103. With edit information included in the edit information file ill, the print control application 104 manages a document based on a management structure independent of the document defined by the save file 103 such as a job ticket. The management structure is a hierarchical structure similar to that of the job ticket. Unlike the structure of the job ticket, however, the management structure has the following layers from top to bottom: “book”, “chapter”, and “source document (logical) page”. The source document page corresponds to the source document page of the job ticket. Furthermore, the chapter corresponds to the sheet bundle of the job ticket.

A document file displayed as a user interface is temporarily built for the user interface when the user performs an operation, such as changing print settings of the save file 103 or issuing a print command, using the print control application 104. Thus, the print control application 104 opens the save file 103 together with the corresponding edit information file 111, loads, from the save file 103 into memory, a despool table (to be described later) having a structure defined by the edit information, and, based on that, displays the structure and preview screen of the document file as a user interface, which will be described later. The document file built with this print control application (bookbinding application) 104 based on the save file 103 and the edit information file 111 is called a book file. In this case, if the edit information file 111 has specific setting items, the user can change the print settings while monitoring the book file via the user interface. The changed settings are reflected on the table (despool table) in the memory, and are saved in the save file 103 and the edit information file 111 if a save command is issued.

Example Format of Edit Information File

The data format of the book file, i.e., the edit information file 111 will be described next, followed by the description of details of the print control application 104. The book file has a three-layer hierarchical structure analogous to a paper book. The upper layer is called “book”, analogous to one book, where attributes for the entire book are defined. The intermediate layer below the upper layer corresponds to chapters of the book, and is called “chapter”. Attributes can also be defined for each of the chapters. The lower layer is called “page”, and corresponds to pages defined by the application program. Attributes can also be defined for each of the pages. One book can contain a plurality of chapters and each chapter can contain a plurality of pages.

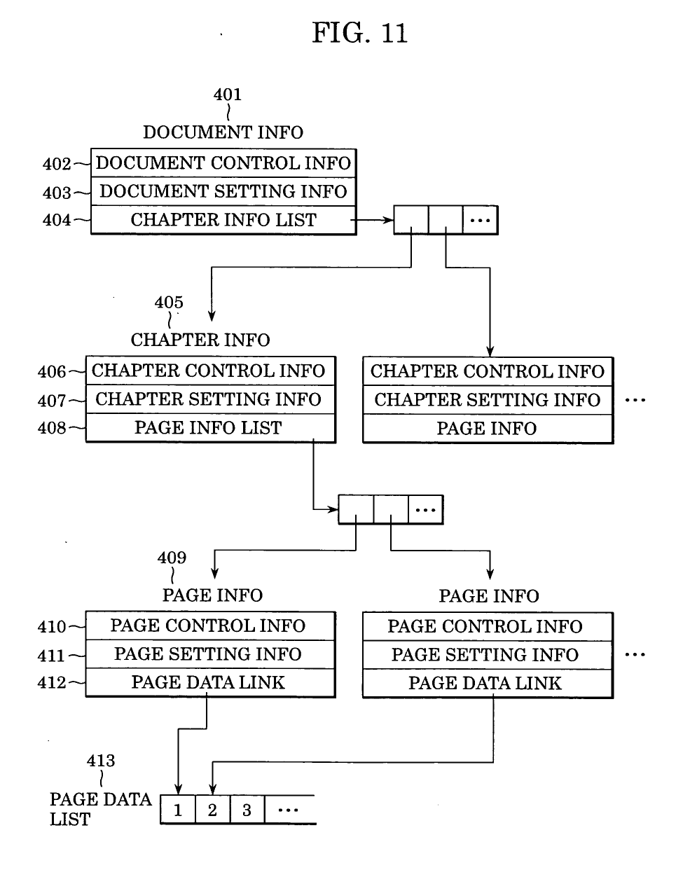

FIG. 11 is a schematic diagram showing one example of the format of a book file. In the book file in this example, a book, chapters, and pages are indicated with respective nodes. One book file includes one book. A book and chapters are concepts for defining the structure of the book, and they are in fact links with defined attribute settings and the lower layer. A page is source document page data in, for example, the PDF format included in the save file 103. More specifically, the edit information file 111 defines the format and attributes of a book file, and does not contain source document page data. A page is data representing each of the pages output by the application program. For this reason, in addition to the attribute settings, a page includes a source document page itself and a link with the corresponding source document page data. A print page output on a sheet of paper may include a plurality of source document pages. This structure is not displayed with links, but is displayed as attributes in the book, chapter, and page layers.

In FIG. 11, a book file does not need to be one complete book, and thus “book” means a general “document”. Information regarding a document is called document information, information regarding chapters is called chapter information, and information regarding pages is called page information.

Referring to FIG. 11, the top layer includes document information 401. The document information 401 includes three parts: document control information 402, document setting information 403, and a chapter information list 404. The document control information 402 holds information such as a path name in the file system of the document file. The document setting information 403 holds layout information such as the page layout and information regarding function settings of the printing apparatus, such as stapling. The document setting information 403 corresponds to book attributes. The chapter information list 404 holds in a list format a collection of chapters constituting the document. This list contains chapter information 405.

The chapter information 405 also includes three parts: chapter control information 406, chapter setting information 407, and page information list 408. The chapter control information 406 holds information such as the name of the chapter. The chapter setting information 407 holds information regarding the page layout specific to the chapter and stapling. The chapter setting information 407 corresponds to chapter attributes. Each chapter has setting information so that a document with a complicated layout, e.g., the first chapter has a 2-UP layout and other chapters have 4-UP layouts, can be generated. The page information list 408 holds in a list format a collection of source document pages constituting each chapter. The page information list 408 points to page information data 409.

The page information data 409 also includes three parts: page control information 410, page setting information 411, and page link information 412. The page control information 410 holds information such as page numbers to be displayed in a tree format. The page setting information 411 holds information such as the page rotation angle and the page location in the layout. The page setting information 411 corresponds to source document page attributes. The page link information 412 is source document data corresponding to a page. In this example, the page information 409 does not have source document data directly, but has only the page link information 412 so that actual source document data is held in the page data list 413.

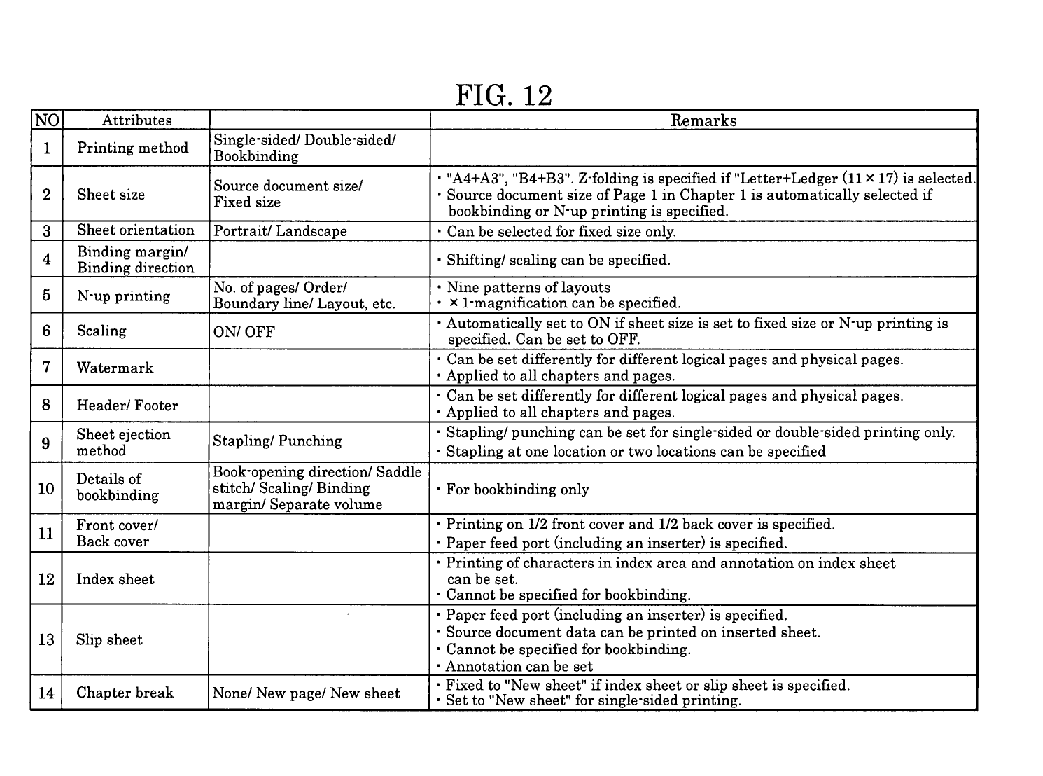

FIG. 12 is a list showing an example of book attributes (document setting information 403). In general, for attributes that can be defined in duplicate with the lower layer, the attribute settings of the lower layer take precedence over those of the upper layer. Based on this rule, settings of attributes specific to the book are effective over the entire book. Settings of attributes duplicating those in the lower layer are used as defaults, i.e., they are effective if no settings are made to the attributes in the lower layer. In this example, however, it is possible to select whether attribute settings in the lower layer take precedence over those in the upper layer, as described later. As shown in FIG. 12, several related items may be integrated into an attribute.

There are four attributes specific to a book: “Printing method”, “Details of bookbinding”, “Front cover/Back cover”, and “Chapter break”. These attributes are effective throughout the book. The “Printing method” attribute includes three options: single-sided printing, double-sided printing, and bookbinding printing. The bookbinding printing is a printing method where a specified number of sheets are bundled and folded in half, and the bundle is then bound for bookmaking. The “Details of bookbinding” attribute allows the user to specify the book-opening direction and the number of sheets to be bundled if bookbinding printing is specified.

The “Front cover/Back cover” attribute includes the specification of whether or not to add a sheet as a front cover or a back cover and the specification of print content to be printed on the added sheet when the electronic source document file corresponding to the book is printed out. The “Index sheet” attribute includes the specification of whether or not to insert a tab index sheet separately prepared by the printing apparatus as a chapter break and the specification of print content to be printed in the index (tab) area. This attribute is available with a printing apparatus having an inserter for inserting a sheet provided separately from the print sheets into a desired location or a printing apparatus having a plurality of paper-feed cassettes. This restriction also applies to the “Slip sheet” attribute. Furthermore, an annotation to be printed on the index sheet can be registered as part of the index attribute. In this case, the information registered includes the print location, character strings, image data to be printed, etc. This annotation can be defined for the “Slip sheet” attribute in the same manner.

The “Chapter break” attribute includes the specification of whether to use a new sheet, to use a new print page, or to do nothing at the chapter break. In single-sided printing mode, the use of a new sheet is equivalent to the use of a new print page. In double-sided printing mode, the specification “use a new sheet” prevents two continuous chapters from being printed on one sheet. In contrast, the specification “use a new print page” may cause two continuous chapters to be printed on one sheet, where one chapter is printed on the front page and the other chapter is printed on the back page of the same sheet.

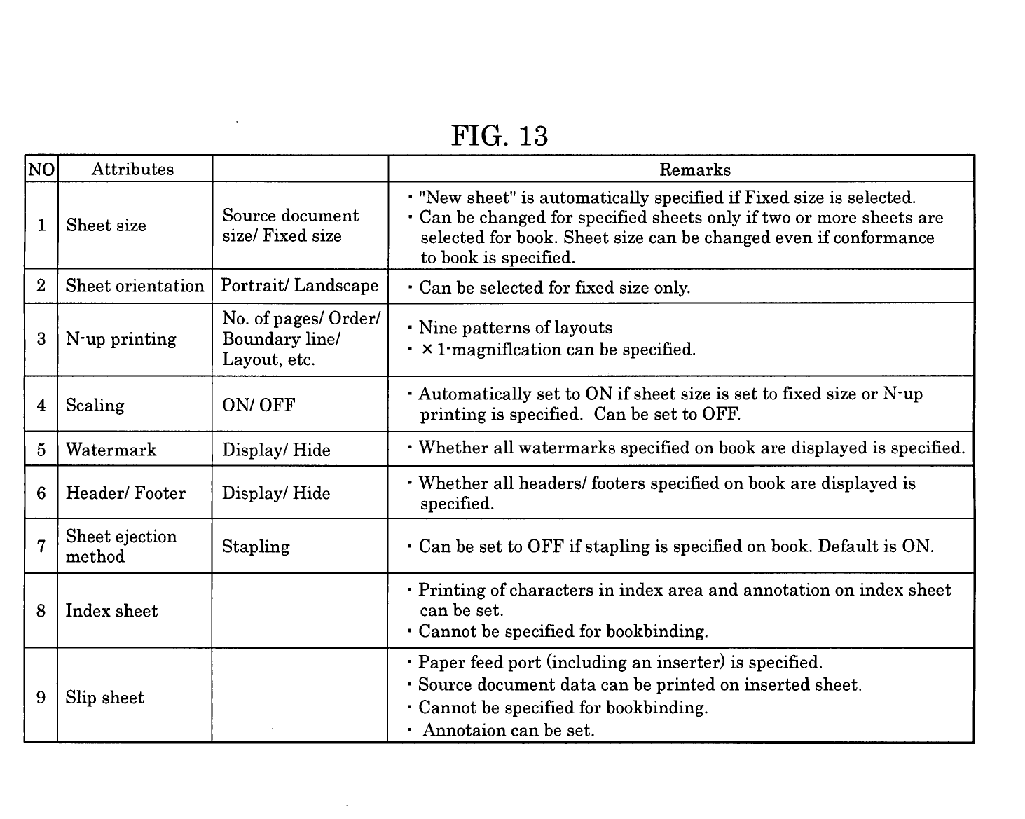

FIG. 13 is a list showing an example of the chapter attributes (chapter setting information 407). The chapter attributes include sheet size, sheet orientation, N-up printing, scaling, watermark, header/footer, sheet ejection information, index sheet, and slip sheet. The “Index sheet” attribute and the “Slip sheet” attribute include the specification of inserting a sheet supplied from the inserter or the paper-feed cassette as a chapter break and the specification of the paper-feed source if a slip sheet is inserted. In addition, if an annotation is to be added to an index sheet or a slip sheet, the “Index sheet” attribute or the “Slip sheet” attribute includes information for identifying the added annotation.

According to the present invention, a book is automatically divided into chapters based on the processing to be described later, and if a chapter sheet is to be set, this “Index sheet” attribute is set to ON to cause the annotation identification information to be described. This enables the annotation to be added to a chapter sheet having no content as source document page data.

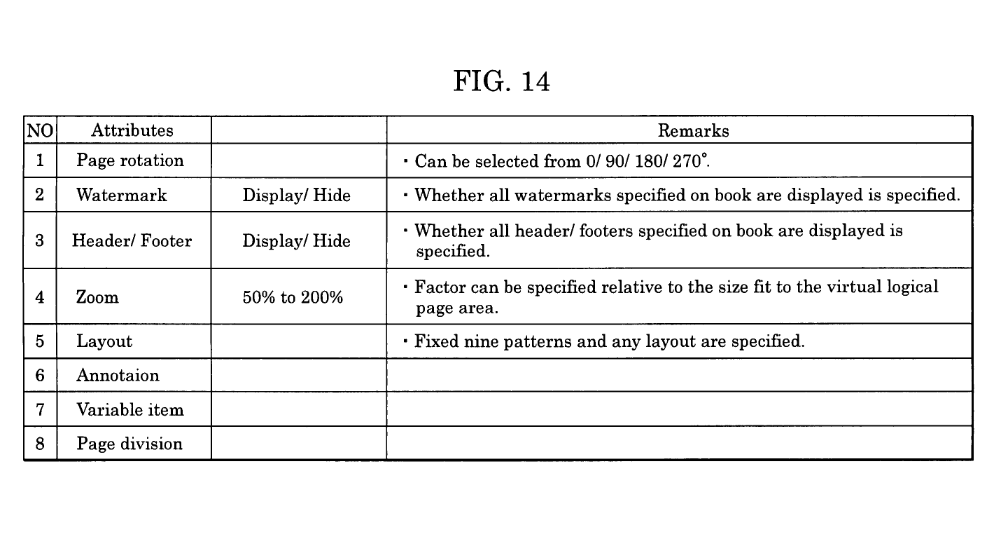

FIG. 14 is a list showing an example of page attributes (page setting information 411). As shown in FIG. 14, there are several page attributes. The “annotation” attribute of the page includes information for identifying the annotation for the source document page data. The annotation of the “Index sheet” attribute shown in FIG. 13 and the “annotation” attribute of the page shown in FIG. 14 both indicate that there is an annotation to be printed on a sheet. Since the “Index sheet” attribute shown in FIG. 13 is related to an index sheet (or slip sheet) which is a sheet having no content of source document page data, the information regarding the annotation cannot be described as a page attribute, unlike the “annotation” attribute in FIG. 14. Thus, the addition of an annotation to an index sheet as a chapter sheet is realized by describing the information as a chapter attribute, as shown in FIG. 13. The relationship between a chapter attribute and a page attribute is the same as the relationship between a book attribute and an attribute of the lower layer.

More specifically, if a setting in a chapter attribute differs from that of the corresponding book attribute, the setting of the chapter attribute takes precedence over the setting of the book attribute. In this example, however, it is possible to select whether attribute settings in the lower layer take precedence over those in the upper layer, as described later.

There are five attributes included as chapter attributes and book attributes: sheet size, sheet orientation, N-up printing, scaling, and sheet ejection method. The “N-up printing” attribute specifies the number of source document pages included in one print page. The layouts that can be specified include 1×1, 1×2, 2×2, 3×3, 4×4, etc. The “Sheet ejection method” attribute specifies whether or not to staple the ejected sheets. This attribute is effective only if the printing apparatus used has a stapling function.

Attributes specific to page include page rotation, zooming, layout, annotation, page division, etc. The “page rotation” attribute specifies the rotation angle applied when the source document page is laid out on a print page. The “zooming” attribute specifies a zoom factor of the source document page. The zoom factor is specified as a relative value to the virtual logical page area which is a 100% zoom factor. The virtual logical page area is an area occupied by one source document page laid out according to the specification of, for example, N-up printing. For the 1×1 layout, for example, the virtual logical page area is the area corresponding to one print page. For the 1×2 layout, the virtual logical page area is the area generated by reducing each side of one print page to about 70%.

The attributes included in all of book, chapter, and page are the “Watermark” attribute and the “Header/Footer” attribute. A watermark is a separately specified image or character string that is superimposed on data generated by the application. A header and a footer are watermarks printed at the top margin and the bottom margin of a page, respectively. Items that can be specified as variables, such as a page number and a date/time, are prepared for the “Header/Footer” attribute. Settings available for the “Watermark” attribute and the “Header/Footer” attribute of a chapter are the same as those of a page, but they are different from those of a book. In a book, the content of the “Watermark” attribute and the “Header/Footer” attribute can be set and how the watermark and the header/footer are to be printed throughout the book can be specified. On the other hand, in a chapter and a page, whether or not the watermark and the header/footer set in the book are to be printed in the corresponding chapter and the page can be specified.

According to this embodiment, the settings of the print format are registered in the form of the above-described attributes based on the scanned image data. The data thus registered corresponds to book attributes which are applied to the entire digitized document.

Output of Edit Information File

An edit information file generated/edited as described above is intended to be eventually printed out. When the user selects a file menu on the UI (user interface) screen of the print control application 104, and then selects the print command, the specified output device performs printing. In this case, the print control application 104 generates data called a despool table, as described above, from the currently open edit information file 111 and the corresponding save file 103 (e.g. a job ticket) and passes the data to the print application 105.

The print application 105 converts the despool table into parameters to be passed to the graphic engine 121.

The print application 105 converts the save file 103 into an output command of the OS, for example, the GDI command of Windows®, and calls the GDI function (graphic engine) with the command as a parameter. The graphic engine 121 makes the specified printer driver 106 generate a command suitable for the device (e.g. printer) and transmit the command to the device. The transmitted command may be a general print command or a command for specifying a printer-specific function, e.g., punching or stapling.

The graphic engine 121 loads the printer driver 106 prepared for each print device from the external memory 211 into the RAM 202 and sets the output to the printer driver 106. The graphic engine 121 then converts the command from the GDI (Graphical Device Interface) function to the DDI (Device Driver Interface) function and calls the DDI function provided by the printer driver 106. Based on the DDI function called from the output module, the printer driver 106 converts the command into a control command recognizable to the printer, for example, PDL. The converted printer control command is output as print data to the printer 1006 via the system spooler 122 loaded into the RAM 202 by the OS and via the printer interface 316.

(Example of Preview Display Content)

As described above, when a book file is opened by the print control application 104, a predetermined user interface screen is displayed. In a tree section, a tree representing the structure of the open document (hereinafter, referred to as a “book of interest”) is displayed. In the preview section, the book of interest is displayed in three display modes according to the specification by the user. The first mode is called a source document view mode, in which source document pages are displayed “as is”. In the source document view mode, reduced versions of the content of source document pages included in the book of interest are displayed. The layout is not reflected on the display in the preview section. The second mode is a print view mode. In the preview section in the print view mode, each of the source document pages is displayed with the layout reflected. The third mode is a simple print view mode. In the simple print view mode, the content of each source document page is not reflected in the preview section but the layout only is displayed.

Procedure for Digitizing Paper Source Document

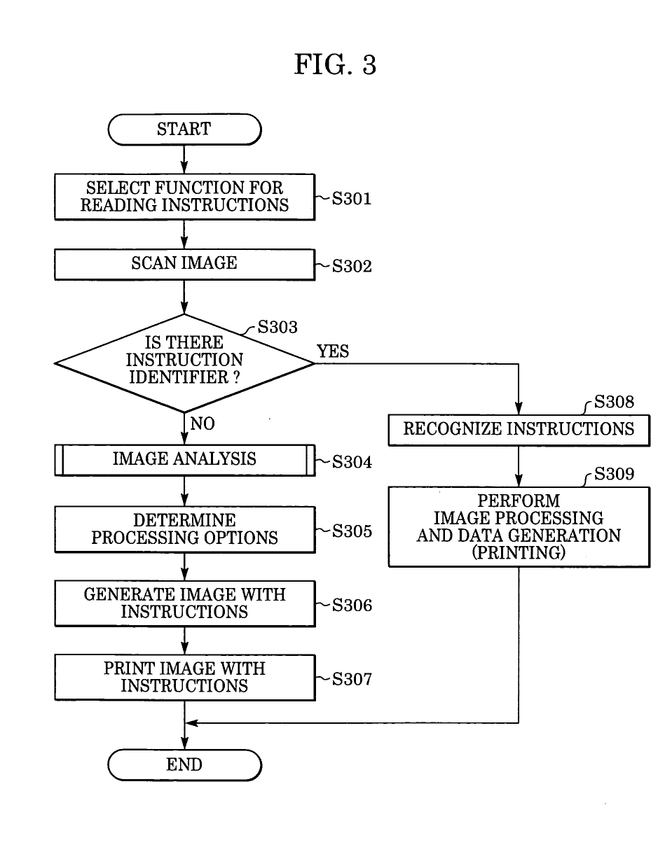

FIG. 3 is a flowchart showing the flow of processing carried out according to this embodiment. Users who wish to specify detailed settings as to the reading of a source document select a function for reading instructions on the operating panel 1005 of the scanner in step S301 and scan the first page or any page of the source document in step S302. Scanned data are transferred to the PC 1003 via the network 1002.

In step S303, the print control application 104 of the personal computer 1003 checks whether or not the image of the transferred image data is a written instruction containing detailed settings specified by the user. A written instruction includes a format for enabling print settings to be read via a scanner. A written instruction is a document additionally provided with an instruction field containing user's detailed settings. Such a written instruction is prepared by pre-reading a paper source document and, based on the reading, determining the print format of the document to allow the user to specify how to reflect the print format on the print settings and how to process the image objects serving as the basis for determining the print format. The user writes additional settings in the written instruction, which is then scanned to enter the settings. A characteristic identification image (identification information) can be added to the written instruction so that the written instruction can be discriminated from a normal source document page. For example, the written instruction may have a bar code representing a serial number for uniquely identifying the written instruction. This added identification information is generated in step S306 described below, and is then printed out as a written instruction in step S307.

If a determination is made in step S303 that the image data that has been read does not indicate a written instruction, whether or not the scanned source document contains an image object showing a particular output format is analyzed in step S304.

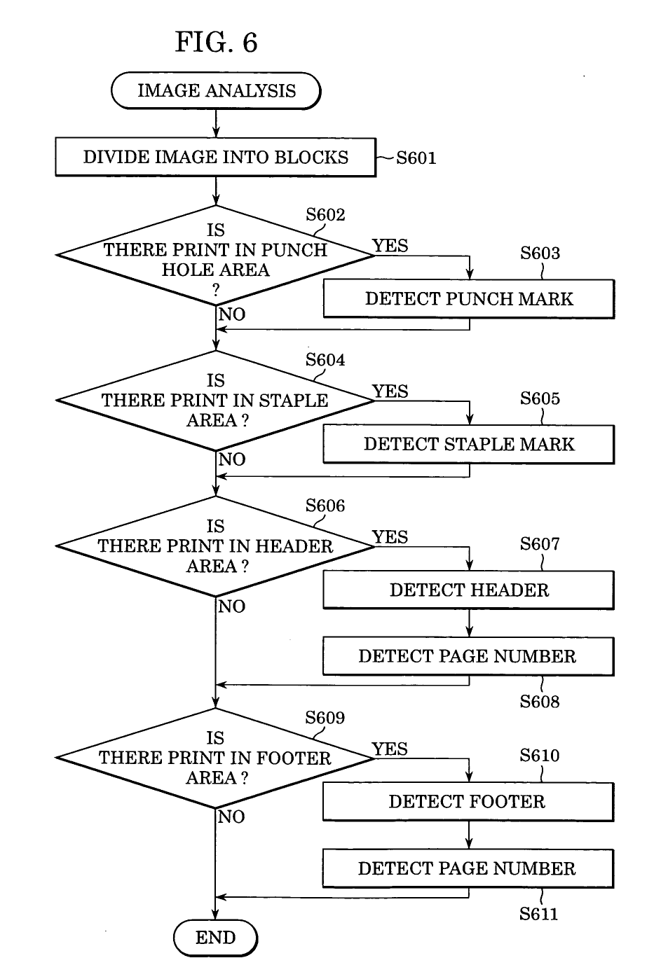

An image object indicates a particular output format item such as a mark corresponding to a punch hole or a staple, or an image related to a predetermined print setting such as a header, a footer, or a page number. In step S304, image analysis is performed to determine whether or not these image objects exist. A procedure for this image analysis will be described in detail later with reference to FIG. 6. In this case, if two or more pages have been scanned, only the first page is subjected to image analysis.

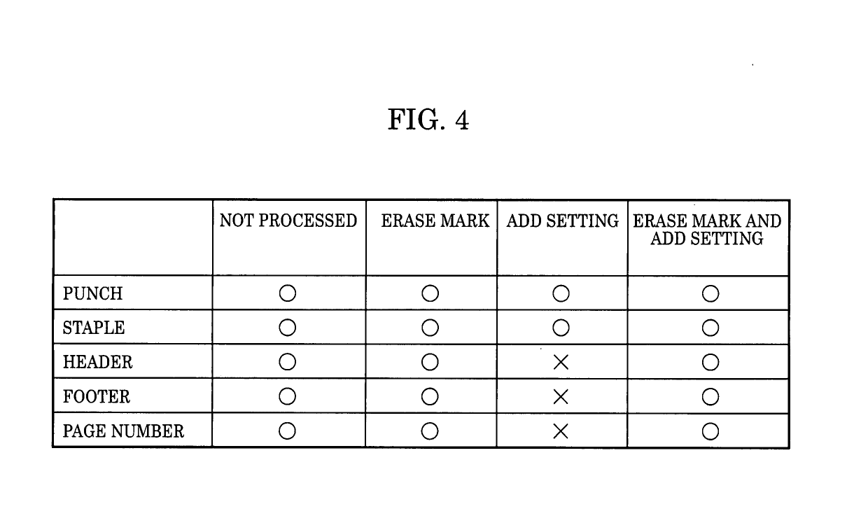

Then in step S305, processing options for each of the image objects extracted as a result of the image analysis in step S304 are determined. For example, such processing options can be set based on a predetermined table as shown in FIG. 4. Alternatively, such processing options can be dynamically determined as image processing and print commands available depending on the capabilities of the relevant document processing system. This will be described later.

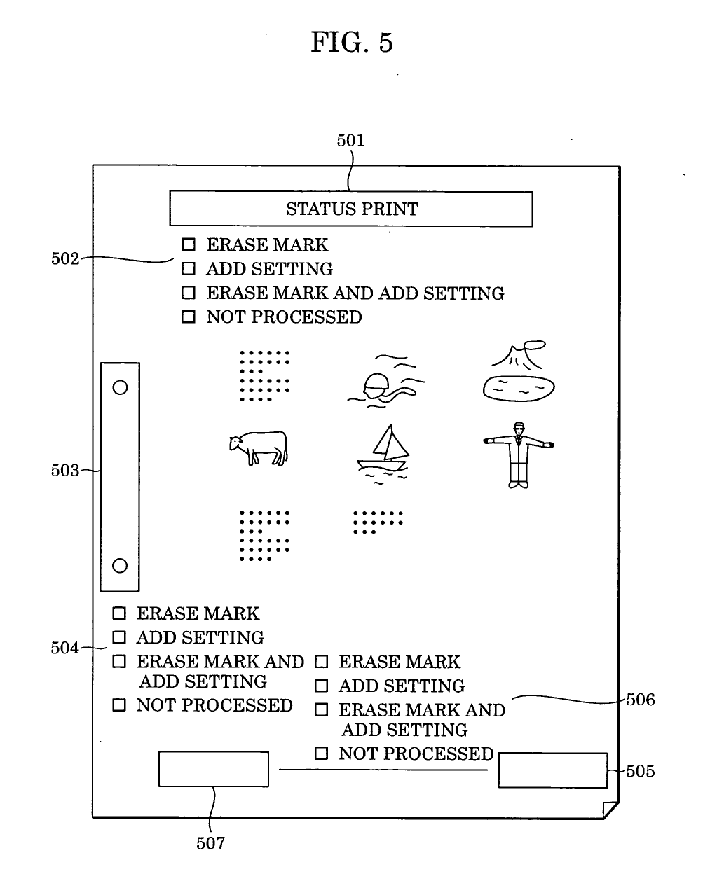

The determined processing options are superimposed on the image scanned in step S302 along with user-selectable marks. The image of a written instruction including the options and their locations and information for identifying the written instruction is generated in step S306. An example of a generated image of a written instruction according to this embodiment is shown in FIG. 5. In the example of FIG. 5, character strings with checkboxes (options 502 for a header 501, options 504 for punch holes 503, and options 506 for a footer 505) are used as selectable processing options. Furthermore, a bar code 507 is added as identification information.

The format used is not limited to a checkbox and a bar code. Any format that allows the user to identify options and select a particular item from among the options is acceptable.

Then, the setting items and their options added to the written instruction are stored in, for example, a RAM for a second entry of the written instruction. It is sufficient to store the locations of checkboxes for the setting items, and options for the checkboxes. In the example of FIG. 5, the locations of the checkboxes for the setting item “punch hole” 504 are stored, as well as options “erase mark”, “Add setting”, “erase mark and add setting”, and “Not processed” linked with the checkboxes. It is also possible to select not to store these items of information. Instead, the written instruction may be read to perform image recognition based on the obtained image data, so that which options are selected can be determined according to the result of the image recognition.

In step S307, the image data of the written instruction generated in step S306 in this manner is again transmitted to the multifunction machine 1001 via the network 1002 and is printed out by the printer 1006.

The user places a check to the desired options in the printed written instruction with, for example, a pen to specify the desired processing, places the written instruction at the beginning of the source document to be scanned, and selects a second reading in step S301 to scan it in step S302.

It is determined in step S303 that the image scanned according to the scan command in step S302 indicates a written instruction due to the identification information in the image. Furthermore, user settings are recognized based on the selected information (processing options and marks) in the image in step S308. For this purpose, another image recognition may be carried out to determine characters, checkboxes, and the output format to recognize the user settings. To effectively utilize the result of recognition in step S304 and maintain consistency with it, the locations of checkboxes for setting items and options for the checkboxes are stored, as described above, when the written instruction is generated in step S306. In step S308, based on the stored information, checkboxes with a check are recognized and the settings corresponding to the checked checkboxes are determined to apply the corresponding processing to the setting items (punch, staple, header, footer, page number, etc.) of the output format.

According to the user's detailed settings recognized in step S308, each of the scanned pages is subjected to the corresponding image processing such as the elimination of specified objects. The image data subjected to image processing is then registered as an electronic document where the image of one page of the source document corresponds to one page. If the option “Add setting” is specified, this print setting is applied to the entire document as described above, and the image data is then generated in step S309.

In step S309, the image data generated by scanning the entire paper document to be digitized is input, and the image data is subjected to image processing according to the settings into an electronic document.

Furthermore, in the case of push scanning, scanned image data is sequentially read from a predetermined folder for processing in step S309. In the case of pull scanning, however, the entire document is controlled so as to repeatedly undergo a loop of processing from steps S302→S303→S308→S309→S302.

At this time, the generated image can be printed out immediately. The format of the generated electronic document in this case is not just an image format, but the document format of the application software capable of bookbinding printing on the PC 1003. For the document format at this time, any format supporting printing and bookbinding can be used, thus providing a simple procedure for user setting.

(Generation of Electronic Document)

A procedure for adding pages to a chapter in the edit information file 111 (electronic document) generated in step S309 will now be described with reference to FIG. 11. First, an image imported for the current chapter 405 is added to the page data list 413 as new page data. A link for the new page data is added to the page data link of the page information list 408 of the current chapter information 405. Then, with the page data link, the image data of the page imported, i.e., read by the scanner, is linked with the current chapter information 405 as page data. If the paper source document has been subjected to double-sided scanning, the “Printing method” attribute (attribute number 1 in FIG. 12) in the document setting information 403 (FIG. 11) has a record of “double-sided”. In contrast, if the paper source document has been subjected to single-sided scanning, “single-sided” is recorded.

On the other hand, although the job ticket (refer to FIG. 15), that is, the save file 103 has a hierarchical structure, it does not have a chapter structure element, unlike the edit information file 111. The job ticket has a structure such that a bundle of common sheets is defined by the sheet information 1102, the sheets belonging to the bundle of sheets are defined by the face information 1103, the faces belonging to the face information are defined by the physical page information 1104, and the source document pages belonging to each item of physical page information are defined by the source document page information 1105. Thus, for example, “chapter” of the edit information file 111 corresponds to “sheet information” of the job ticket. Thus, the addition of a new page to the job ticket is carried out as follows, with reference to FIG. 15. New face information 1103 to be linked with the sheet information 1102 corresponding to the current chapter is added. Furthermore, physical page information 1104 is added to the face information 1103, and new source document page information 1105 to be linked with the physical page information 1104 is added. Then, the imported image data is linked as a new page with the page data link of the source document page information 1105. If the paper source document has been subjected to double-sided scanning, a continuous odd-number page and even-number page are linked in that order with the face information 1103 as physical page information and source document page information connected thereto. If the paper source document has been subjected to single-sided scanning, the read page is linked with the face information 1103 as physical page information and the source document page information connected thereto.

According to the above-described procedure, an electronic source document file having a single chapter is generated in step S309. Although an electronic source document file is newly generated in this procedure, an electronic source document file may be added to the existing electronic source document file. If an electronic source document file is added to the existing electronic source document file, the read image data may generate a new chapter or may be added to the existing chapter.

(Options Table for Output Format)

The table shown in FIG. 4 referred to in step S305 will now be described. FIG. 4 shows predetermined options for specifying how to process the marks on the output format (objects corresponding to the marks in the image). In FIG. 4, it is assumed that five items: “punch”, i.e., punch hole, “staple”, “header”, “footer”, and “page number” have been determined as output format settings through image analysis. One of “Not processed”, “Erase mark”, “Add setting”, and “Erase mark and add setting” can be selected for “punch” and “staple”. One of “Not processed”, “Erase mark”, and “Erase mark and add setting” can be selected for “header”, “footer”, and “page number”. In short, if a written instruction is generated based on the table shown in FIG. 4, processing indicated by circles is determined in step S305 as options to be reflected on the format determined as a result of the image analysis in step S304. The table in FIG. 4 is saved in a hard disk, a RAM, or a non-volatile memory such as a ROM. The content of the table may be pre-determined or may be constructed so as to be changed by the user via the user interface. For some processing items, such as stapling and punching, available options (“Add setting” and “Erase mark and Add setting” in the table of FIG. 4) for such processing items are determined depending on the output device (multifunction machine 1001). Thus, when the table of FIG. 4 is defined, a reference is made to the output device for the functions available on the device. In the table shown in FIG. 4, “Not processed” indicates that no processing is carried out even if the output format corresponding to the item is detected. “Erase mark” indicates that, if the output format corresponding to the item is detected, the mark is eliminated from the image data. For example, with “Erase mark” specified, if punch hole is detected, the object in the image corresponding to the punch hole is eliminated. If staple is detected, the object in the image corresponding to the staple mark is eliminated. If the header, footer, or page number is detected, the object (character string) in the image corresponding to the header, footer, or page number is eliminated.

“Add setting” indicates that the document setting information (book attributes) corresponding to the detected output format is set. For example, with “Add setting” specified, if punch hole is detected, the parameters (parameters for punching and the location of the punching according to No. 9, “Sheet ejection method”, as a book attribute in FIG. 12) for punching in book attribute are set. If staple is detected, the parameters (parameters for stapling and the location of the stapling in No. 9, “Sheet ejection method”, as a book attribute in FIG. 12) for stapling in the book attribute are set. If a header, a footer, or a page number is detected, the parameters corresponding to the header, footer, or page number (parameters indicating the printing of the header, footer, or page number, the content of the header, footer, or page number, and the location of the page number according to No. 8, “Header/Footer”, as a book attribute in FIG. 12) are set.

“Erase mark and add setting” indicates that both “Erase mark” and “Add setting” are to be carried out.

(Image Analysis Procedure)

FIG. 6 is a flowchart illustrating in detail one example of the image analysis in step S304. For the input image, areas other than the white areas are identified as blocks in step S601 such that a group of non-white portions corresponds to one block. Various algorithms are disclosed for dividing print areas into blocks. According to the present invention, any of such algorithms can be employed.

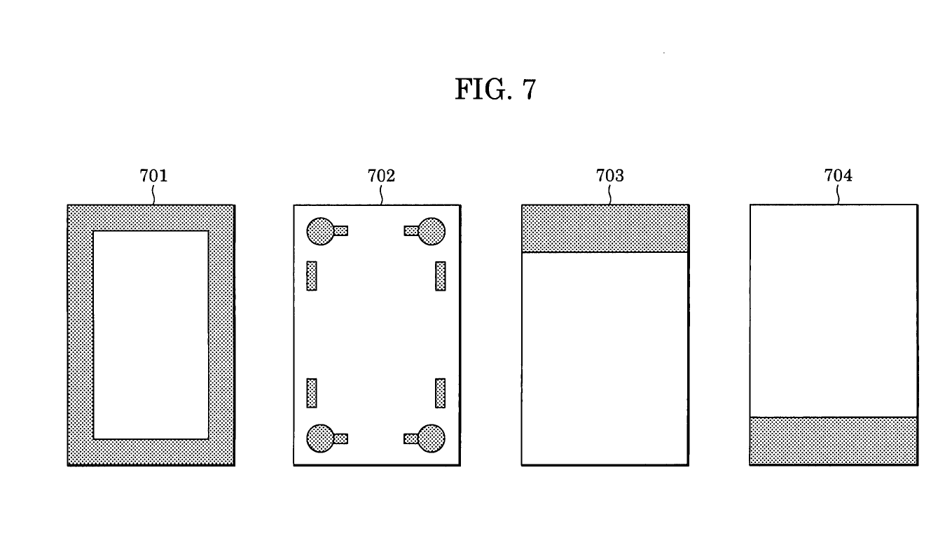

If there is print in the area where punch holes normally exist in step S602 as a result of identifying print areas, the print included in the area is recognized as punch-hole marks in step S603. The area in which punch holes normally exist is pre-defined. One example is a shaded area 701 shown in FIG. 7. Punch holes are normally recognized as a series of two or three circles with substantially constant diameters arranged in line. Thus, the recognition accuracy of punch holes is improved by finding a series of circles existing in the shaded area 701 of FIG. 7.

Similarly, if there is print in the area where a staple normally exists in step S604 as a result of identifying print areas, the print included in the area is recognized as a staple mark in step S605. The area in which a staple normally exists is pre-defined. One example is a shaded area 702 shown in FIG. 7. The recognition accuracy of a staple is improved by recognizing it as an image of a line with a constant length.

Similarly, if there is print in the area where a header normally exists in step S606 as a result of identifying print areas, the print included in the area is recognized as a header mark in step S607. The area in which a header normally exists is pre-defined. One example is a shaded area 703 shown in FIG. 7. In many cases, a header includes a character string. Thus, the recognition accuracy of a header is improved by recognizing it as characters. If the result of image recognition indicates that the area includes numerical characters only, the print in the area is identified as a page number in step S608. Various algorithms for identifying numerical characters from an image are disclosed. For the present invention, any of such known algorithms can be used.

Similarly, if there is print in the area where a footer normally exists in step S609 as a result of identifying print areas, the print included in the area is recognized as a footer mark in step S610. The area in which a footer normally exists is pre-defined. One example is a shaded area 704 shown in FIG. 7. If the result of image recognition indicates that the area includes numerical characters only, the print in the area is identified as a page number in step S611. Various algorithms for identifying numerical characters from an image are disclosed. For the present invention, any of such known algorithms can be used.

According to the above-described procedure, the first or any page of a source document is pre-scanned and is then subjected to image analysis, so that image processing settings that can be specified for print-setting areas in the recognized source document and bookbinding settings for saving or printing the source document as an electronic document can be presented to the user as selectable options. This allows the user to specify simple correction settings and bookbinding settings when the source document is scanned.

Furthermore, the print format according to user settings of the paper source document can be reflected on the corresponding electronic document with a simple operation. This simplifies the operation and improves the image quality of the generated electronic document.

### Second Embodiment

According to the first embodiment, user's detailed settings are entered by reading a document containing the settings. According to a second embodiment, user's detailed settings are entered via an input device such as a bitmap display and a touch panel.

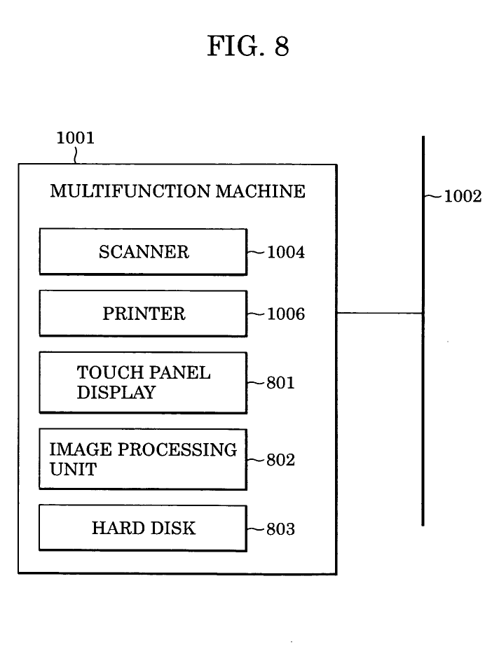

FIG. 8 is a block diagram illustrating the structure of a document processing system suitable for the second embodiment according to the present invention. The same components as those in FIG. 1 will not be described again. Referring to FIG. 8, the multifunction machine 1001 includes the functions of the scanner 1004 and the printer 1006. The multifunction machine 1001 includes a touch panel display 801. The image scanned by the scanner 1004 can be displayed on this touch panel display 801. Furthermore, the displayed image can be corrected by entering instructions on the touch panel display 801. According to the correction instruction, an image processing unit 802 performs image processing and outputs the corrected image to the printer 1006. Furthermore, the image data with the output settings maintained can be saved to a hard disk 803, and then can be subjected to a second correction or printing. The touch panel display 801 can be replaced with a bitmap display and a pointing device.

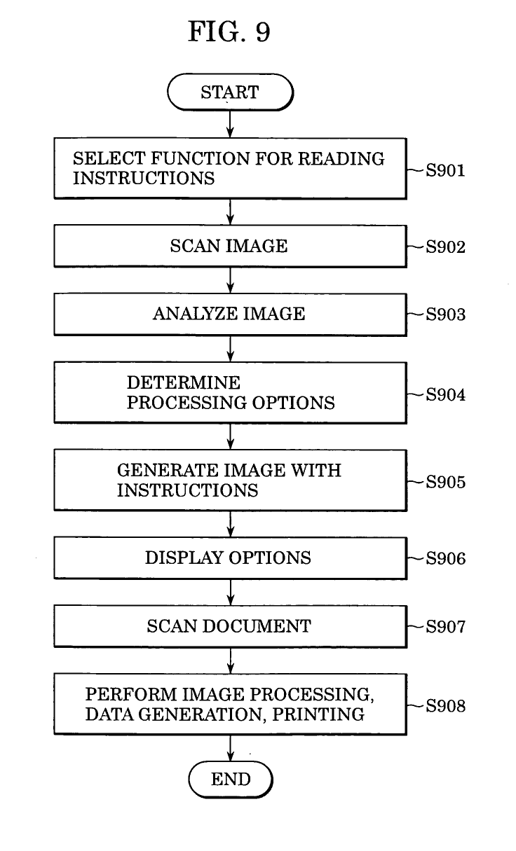

FIG. 9 is a flowchart showing the flow of processing carried out according to this embodiment. Unlike the processing in FIG. 3, the steps before step S908 of the processing in FIG. 9 are carried out by the multifunction machine 1001. The only difference between the processing in FIG. 3 and the processing in FIG. 9 is as follows. That is, in FIG. 3, a written instruction is output as a print product and user settings are specified in the print product, which is again input. In FIG. 9, however, the image of a written instruction is displayed on the touch panel 801 so that the user can specify settings on the touch panel 801. This difference will be described in detail with reference to FIG. 9. The same processing as in FIG. 3, such as image analysis, generation of a written instruction, and generation of an electronic document in step S908, will only be briefly described here.

Users who wish to specify detailed settings as to the reading of a source document select a function for reading instructions on the touch panel display 801 in step S901 and scan the first page or any page of the source document in step S902.

In step S903, image analysis is performed with the image processing unit 802 to determine whether or not there is a punch hole, a staple, a header, a footer, or a page number in the scanned source document. This image analysis is performed in the same manner as with the first embodiment. In this case, if two or more pages have been scanned, only the first is subjected to image analysis.

Then in step S904, processing options for each of the characteristic portions extracted as a result of the image analysis are determined. In step S905, the determined processing options are superimposed on the image scanned in step S902 as user-selectable buttons on the touch display panel 801. The options used in this case may be realized in any form including a button and a dropdown list.

The image generated in step S905 is displayed on the touch panel display 801 in step S906. The user specifies desired detailed settings from among the options on the touch panel display 801. The paper source document is subjected to a second scanning in step S907.

Each of the pages of the source document image that have been scanned is subjected to image processing according to the user's detailed settings, and the print settings are applied to the entire document to generate image data in step S908.

The generated image data with print settings applied may be printed out “as is” from the printer 1006 or may be saved to the hard disk 803 with the settings maintained.

The above-described processing can also be performed with the structure shown in FIG. 1 by replacing the touch panel display 801 according to this embodiment with the display 210 and the keyboard 209 on the PC 1003.

As described above, the second embodiment can offer the same advantages as those according to the first embodiment. In addition, since it is not necessary to print out a written instruction according to this embodiment, print settings according to user settings can be entered even in an environment where no printer is available to apply image processing according to user settings for the digitization of a paper source document.

### Third Embodiment

If the source document to be digitized has print on both front and back faces, applying the same image processing settings to all pages is not desired in some cases. For example, in many cases, a punch hole mark of the front face appears on the left of the page, whereas a punch hole mark of the back face appears on the right of the page. Therefore, if print settings and image processing are applied to the entire document based on one page that has been pre-scanned and recognized as an image in the same manner as the first embodiment or the second embodiment, inappropriate image processing will be carried out. Thus, according to a third embodiment, a case where the source document has print on both front and back faces will be described.

FIG. 1 is a block diagram for describing the structure of a document processing system to which this embodiment is applied. A flowchart showing the flow of processing carried out according to this embodiment is shown in FIG. 3 as with the first embodiment. Also, the following description mainly focuses on the differences from the first embodiment. That is, the processing common to the first embodiment will be described only briefly. Furthermore, according to this embodiment, the scanner may be provided with an ADF that can scan both faces of a sheet.

Users who wish to specify detailed settings as to the reading of a source document select a function for reading instructions on the operating panel 1005 of the scanner in step S301 and scan the first page and the subsequent back page or any page and the subsequent page of the source document in step S302. It should be noted here that the scan order at this time must be identical to the scan order of the subsequent scanning of the entire source document. More specifically, if the entire source document is to be scanned sequentially starting with the first page, scanning in step S302 must be carried out in the order of odd-number page→even-number page. In contrast, if the entire source document is to be scanned sequentially starting with the last page, scanning in step S302 must be carried out in the order of even-number page→odd-number page.

Scanned data are transferred to the PC 1003 via the network 1002, and in step S303, it is checked whether or not the image is a written instruction containing detailed settings specified by the user.

If a determination is made that the image data that has been read does not indicate a written instruction, it is analyzed in step S304 whether or not the scanned source document contains a mark of a punch hole, a staple, a header, a footer, or a page number. Details of this image analysis are the same as those of the first embodiment. At this time, if two or more pages have been scanned, only the first two pages are to be subjected to image analysis.

Then in step S305, processing options that can be applied to an output format, such as punching, stapling, a header, a footer, and a page number, extracted as a result of the image analysis are determined. For example, such processing options can be set based on a predetermined table, as shown in FIG. 4. Alternatively, such processing options can be dynamically determined as image processing and print commands available depending on the capabilities of the relevant document processing system.

The determined processing options are superimposed on the image scanned in step S302 along with user-selectable marks. Finally, the image of a written instruction including the options and their locations and information for identifying the written instruction is generated in step S306. A point different from the first embodiment is that written instruction for two pages, i.e., the front and back faces of the source document are generated in step S306.

The images of the written instruction generated in step S306 are again transmitted to the printer 1006 via the network 1002 and are printed with the double-sided printing setting in step S307.

In the same manner as with the first embodiment, the user places a check at the desired options in the printed written instruction with, for example, a pen to specify the desired processing, places the written instruction at the beginning of the source document to be scanned, and selects a second reading in step S301 to scan it in step S302. Here, both faces of the source document are scanned.

It is determined in step S303 that the image scanned according to the scan command in step S302 indicates a written instruction due to the identification information in the image, and based on the identification information, two pages (front and back pages) of user's detailed settings are recognized in step S308.

According to user's detailed settings recognized in step S308, the settings as to the method for processing the front page are reflected on image processing of every other page from the first page. Similarly, the settings as to the method for processing the back page are reflected on image processing of every other page from the second page. More specifically, according to, for example, a delete instruction, the object corresponding to the specified output format is deleted from the image of each page. Image data with the specified print settings applied to the entire document is generated. Thus, an electronic document including the generated image data is produced in step S309. The format of the generated electronic document in this case is not just an image format, but the document format of the application software capable of bookbinding printing on the PC 1003. For the document format at this time, any format supporting printing and bookbinding can be used, thus producing a simple procedure for user setting.

According to the procedure of the above-described embodiment, the present invention can easily be applied even in a case where both front and back faces of a source document are read. According to the above-described procedure, even in a case where the front and back pages of a sheet are read, the first or any page of a source document is pre-scanned and is then subjected to image analysis. Thus, image processing settings that can be specified for print-setting areas in the recognized source document and bookbinding settings for saving or printing the source document as an electronic document can be presented to the user as selectable options. This allows the user to specify simple correction settings and bookbinding settings when the source document is scanned.

Furthermore, the print format according to user settings of a paper source document can be reflected on the corresponding electronic document with a simple operation. This simplifies the operation and improves the image quality of the generated electronic document.

In addition, a determination step may be additionally placed before step S301 so that which of the first and third embodiments is to be used is automatically selected depending on whether single-sided or double-sided scanning is performed in step S302.

### Other Embodiments

The present invention can be applied to a system including a plurality of devices (e.g., a host computer, interface, reader, printer, etc.) or to an apparatus including a single device (e.g., a copier, printer, or facsimile machine, etc.).

Furthermore, a storage medium storing software program code (FIGS. 3, 6, and 9) for performing the functions of the foregoing embodiments may be provided to a system or an apparatus, reading the program code with a computer (e.g., a CPU or MPU (micro-processing unit)) of the system or apparatus from the storage medium, and then executing the program. In this case, the program code read from the storage medium implements the functions of the foregoing embodiments.

Further, the storage medium, such as a floppy disk, hard disk, optical disk, magneto-optical disk (MO), CD-ROM (compact disk-ROM), CD-R (compact disk-recordable), magnetic tape, non-volatile memory card or ROM can be used to provide the program code.

Furthermore, besides the case where the functions according to the embodiments are implemented by executing the program code read by a computer, the present invention covers a case where the operating system or the like working on the computer implements the functions according to the embodiments by performing a part of or the entire process in accordance with the commands of program code.

The present invention further covers a case where, after the program code read from the storage medium is written in a memory of a function extension board inserted into the computer or in a memory of a function extension unit connected to the computer, the CPU or the like in the function extension board or function extension unit implements the function of the above embodiments by performing a part of or the entire process in accordance with the commands of the program code.

As described above, according to the above-described embodiments, any page of a document to be digitized is pre-scanned, and based on the pre-scanned image, objects related to the output format are determined. The user is then allowed to confirm the output format and specify how to process these objects. This enables the user to reproduce, for example, the output format of the paper source document as an electronic document with a simple operation.

If a source document is scanned with a known scanner, it is difficult to specify detailed settings with the known scanner due to a restricted display and input device of the scanner. For this reason, for the known scanner, the user needed to read a scan image into a personal computer and preview the image to specify settings while monitoring the image on the personal computer. Furthermore, the user needed to go back and forth between the personal computer and the scanner each time the user changed settings or needed to install the scanner near the personal computer to avoid going back and forth between the personal computer and the scanner. According to the above-described embodiments, these problems can be solved.

In addition, with a known scanner, when print settings such as stapling, punching, or N-up printing (layout where N-pages of a source document are arranged on one sheet) are to be applied to a scanned image, the input device of the scanner, which has restricted functions, had to be used to specify such settings. That is, it was difficult to specify print settings simply. According to the above-described embodiments, these problems can be solved.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-417196 filed Dec. 15, 2003, which is hereby incorporated by reference herein.

1. A document processing apparatus comprising:
a first determination unit configured to determine, as an image processing option, an object related to a predetermined print setting included in image data corresponding to a page of a source document read by an image reading unit for reading the source document as image data; and
an output unit configured to output the image processing option, determined by the first determination unit, with a form that allows a user to select whether the image processing option is performed.

2. The document processing apparatus according to claim 1, further comprising a document production unit configured to produce an electronic document including image data generated by applying image processing to the object as the image processing option.

3. The document processing apparatus according to claim 2, further comprising a second determination unit configured to determine the predetermined print setting for the object.

4. The document processing apparatus according to claim 3, wherein the document production unit produces an electronic document including image data read by the image reading unit and the predetermined print setting determined by the second determination unit is registered in the electronic document.

5. The document processing apparatus according to claim 1, further comprising a second determination unit configured to determine the predetermined print setting for the object.

6. The document processing apparatus according to claim 5, wherein the second determination unit determines a print setting for the object included in the image data according to a position of the object.

7. The document processing apparatus according to claim 5, wherein the second determination unit is configured to apply a print setting to the object as the image processing option determined by the first determination unit according to a specified processing method and to determine a method for processing the object.

8. The document processing apparatus according to claim 5, wherein the second determination unit is configured to identify the object corresponding to at least one of a punch hole, a staple, a header, a footer, and a page number included in the image data and to determine the object as a print setting item for the source document.

9. The document processing apparatus according to claim 5, wherein the second determination unit is configured to implement the object as a print setting item and output at least one option of a method for processing the object to enable a user to specify one of the at least one option and to determine the print setting and the method for processing the object as specified by the user.

10. The document processing apparatus according to claim 9, further comprising a print unit configured to perform printing based on the image data, wherein the print unit implements the object as a print setting item and superimposes an instruction image including an option of a method for processing the object on the image data to print out an output product, and the second determination unit is configured to perform a second reading of the output product by the image-reading unit to identify a specification by the user and to determine the print setting and method for processing.

11. The document processing apparatus according to claim 10, wherein the instruction image includes a checkbox option or a mark sheet option for specifying the method for processing.

12. The document processing apparatus according to claim 9, further comprising:
a display unit configured to perform display based on the image data; and
an input unit,
wherein the display unit is configured to implement the object as a print setting item and display an instruction image including an option of a method for processing the object, and the second determination unit is configured to determine the print setting and method for processing specified by the input unit.

13. The document processing apparatus according to claim 1, wherein the image reading unit is configured to read a front page and a back page of the source document and the first determination unit is configured to determine a print setting applied to each of the front page and the back page based on an object included in the image data of the respective front page and back page.

14. A document processing method comprising:
determining, as an image processing option, an object related to a predetermined print setting included in image data corresponding to a page of a source document read by an image reading unit for reading the source document as image data; and
outputting the image processing option, with a form that allows a user to select whether the image processing option is performed.

15. The document processing method according to claim 14, further comprising producing an electronic document including image data generated by applying image processing to the object as the image processing option.

16. The document processing method according to claim 15, further comprising determining a predetermined print setting for the object.

17. The document processing method according to claim 16, wherein an electronic document including image data read by the image reading unit is produced and the predetermined print setting determined is registered in the electronic document.

18. The document processing method according to claim 14, further comprising determining a predetermined print setting for the object.

19. The document processing method according to claim 18, wherein a print setting for the object included in the image data is determined according to a position of the object.

20. The document processing method according to claim 18, wherein a print setting is applied to the object as the image processing option determined according to a specified processing method and a method for processing the object is determined.

21. The document processing method according to claim 18, wherein the object corresponding to at least one of a punch hole, a staple, a header, a footer, and a page number included in the image data is identified and determined as a print setting item for the source document.

22. The document processing method according to claim 18, wherein the object is implemented as a print setting item and at least one option of a method for processing the object is output to enable a user to specify one of the at least one option and the print setting and the method for processing the object are determined as specified by the user.

23. The document processing method according to claim 22, further comprising making a print unit perform printing based on the image data, wherein, the object is implemented as a print setting item and an instruction image including an option of a method for processing the object is superimposed on the image data to make the print unit print out an output product, and the image-reading unit performs a second reading of the output product to identify a specification by the user and the specified print setting and method for processing are determined.

24. The document processing method according to claim 23, wherein the instruction image includes a checkbox option or a mark sheet option for specifying the method for processing.

25. The document processing method according to claim 22, further comprising making a display unit perform display based on the image data, wherein the object is implemented as a print setting item and the display unit displays an instruction image including an option of a method for processing the object, and, a print setting and a method for processing specified by an input unit are determined.

26. The document processing method according to claim 14, wherein the image reading unit reads a front page and a back page of the source document and, a print setting applied to each of the front page and the back page is determined based on an object included in the image data of the respective front page and back page.

27. A computer-executable program comprising instructions for:
determining, as an image processing option, an object related to a predetermined print setting included in image data corresponding to a page of a source document read by an image reading unit for reading the source document as image data; and
outputting the option, with a form that a user can select whether the image processing option is performed, determined.

28. A document processing apparatus comprising:
an image reading unit configured to read a page of a source document as image data including a predetermined print setting;
an image analysis unit configured to determine, as an image processing option, processing instructions based on the predetermined print setting included in the image data corresponding to the page of the source document read by the image reading unit; and
an output unit configured to output the image processing option, determined by the image analysis unit.

29. A document processing method comprising:
reading a page of a source document as image data including a predetermined print setting;
determining, as an image processing option, processing instructions based on the predetermined print setting included in the image data corresponding to the page of the source document read; and
outputting the image processing option determined.
